(19) United States
(12) Patent Application Publication
(10) Pub. No.: US 2021/0101442 A1
(43) Pub. Date: Apr. 8, 2021

(54) VEHICLE AIR CONDITIONING DUCT

(71) Applicant: Toyota Jidosha Kabushiki Kaisha, Toyota-shi Aichi-ken (JP)

(72) Inventors: Akira Nishino, Toyota-shi (JP); Tomoki Taira, Nagoya-shi (JP)

(21) Appl. No.: 17/038,119

(22) Filed: Sep. 30, 2020

(30) Foreign Application Priority Data
Oct. 2, 2019 (JP) 2019-182350

(51) Int. Cl. B60H 1/00; B60H 1/24

(52) U.S. Cl. CPC B60H 1/00564; B60H 1/246

(57) ABSTRACT

A vehicle air conditioning duct for introducing air from an air conditioner to a rear seat includes: an air intake section; a curved section arranged on a side face of a floor tunnel and connected to a lower part of the air intake section; a main body section connected to a rear part of the curved section and extending toward the vehicle rear along the floor tunnel; and an air discharge section, which is connected to a lower part of a rear end portion of the main body section, and which, at a location under a rear end of a front seat, extends outward in the vehicle width direction, the air discharge section having a blowing outlet for blowing air toward the rear seat.

### CROSS REFERENCE TO RELATED APPLICATION

This application claims priority to Japanese Patent Application No. 2019-182350 filed on Oct. 2, 2019, which is incorporated herein by reference in its entirety including the specification, claims, drawings, and abstract.

### TECHNICAL FIELD

The present disclosure relates to a structure of a vehicle air conditioning duct, and more particularly to a structure of a vehicle air conditioning duct for introducing air from an air conditioner disposed in a front part of a vehicle to a rear seat.

### BACKGROUND

In a vehicle, it is often the case that an air conditioner is disposed in a front part of the vehicle, and cool air or warm air from the air conditioner is blown from a front area of the vehicle cabin through the vehicle cabin. In this case, conditioned air may fail to be sufficiently carried out for the rear seat. For this reason, there have been proposed structures for introducing air from the air conditioner to the rear seat via a duct. For example, JP 2014-196028 A discloses a duct structure, in which a duct extends toward below from an air conditioner disposed in a front part of the vehicle, passes under a floor panel disposed centrally in the vehicle width direction, and branches to left and right so as to extend widthwise, and in which the branches of the duct bend upward at locations below the respective front seats so as to extend above the floor panel, subsequently bend toward the rear of the vehicle, and open toward the rear seat.

In an area under the floor panel disposed centrally in the vehicle width direction, there may be arranged devices such as a high voltage cable connecting between a battery disposed toward the vehicle rear and a motor disposed toward the vehicle front, various wire harnesses, and a drive shaft connecting between an engine disposed toward the vehicle front and the rear wheels. Further, there are also cases in which a battery is installed under the floor panel. For this reason, if an air conditioning duct is arranged under the floor panel as described in JP 2014-196028 A, the installation space for these devices may become confined. Here, consideration might be given to arranging the air conditioning duct above the floor panel and inside the vehicle cabin, and to configure such that, at a location below a central part of a front seat, the air conditioning duct extending outward in the width direction is bent rearward so as to blow air toward the rear seat. However, if the air conditioning duct is arranged below the central part of the front seat, the installation space for devices disposed in this area may then become confined.

In view of the above, the present disclosure is directed to reducing space occupied by an air conditioning duct so as to increase device installation space.

### SUMMARY

A vehicle air conditioning duct according to the present disclosure is a vehicle air conditioning duct which is arranged inside a vehicle cabin and which introduces air from an air conditioner disposed in a front part of a vehicle to a rear seat. The duct includes an air intake section; a curved section, which is connected to a lower part of the air intake section, and which is arranged on a side face of a floor tunnel, the floor tunnel projecting upward from a floor of the vehicle cabin at a central location in a vehicle width direction and extending in a vehicle longitudinal direction; a main body section connected to a rear part of the curved section and extending toward a vehicle rear along the floor tunnel; and an air discharge section, which is connected to a lower part of a rear end portion of the main body section, and which, at a location under a rear end of a front seat, extends outward in the vehicle width direction, the air discharge section having a blowing outlet for blowing air toward the rear seat.

As such, the curved section and the main body section are arranged on the side face of the floor tunnel, and, at a location under the rear end of the front seat, the air discharge section extends outward in the vehicle width direction, and serves to blow air toward the rear seat. With this arrangement, the air conditioning duct does not extend under the central part of the front seat, so that, in the area under the front seat, the space occupied by the air conditioning duct can be reduced and device installation space can be increased.

In a vehicle air conditioning duct according to the present disclosure, the air intake section and the curved section each have a flat shape having a width larger than a height, and are each arranged such that a widthwise face faces the side face of the floor tunnel, with a sound absorbing material placed therebetween. The curved section is smaller in width than the air intake section, and the curved section is configured such that its front part located toward a vehicle front comprises a nozzle portion which has a width that gradually narrows as the nozzle portion extends downstream from a side end of the air intake section toward the vehicle rear. A part of the sound absorbing material may be arranged between a lower face of the nozzle portion and the floor.

Since the air intake section and the curved section each have a flat shape having a width larger than a height, and are each arranged such that a widthwise face faces the side face of the floor tunnel, the height by which the air intake section and the curved section project from the side face of the floor tunnel toward the front seat can be reduced, so that the distance between the front seat and the floor tunnel can be made smaller to thereby achieve a compact structure. Further, by arranging a part of the sound absorbing material between the lower face of the nozzle portion and the floor, a front part of the air conditioning duct can be supported by the sound absorbing material. Accordingly, fluttering of the air conditioning duct during travelling can be suppressed.

In a vehicle air conditioning duct according to the present disclosure, the curved section has a flat shape having a width larger than a height, is arranged such that a widthwise face faces the side face of the floor tunnel, and includes: a flow path portion for allowing flow of conditioned air; and a bag-shaped portion formed in a bag shape and in communication with the flow path portion. The bag-shaped portion may be arranged at a location above the flow path portion and close to a lower end of a console box disposed above the floor tunnel.

Since the curved section has a flat shape having a width larger than a height, and is arranged such that a widthwise face faces the side face of the floor tunnel, the height by which the curved section projects from the side face of the floor tunnel toward the front seat can be reduced, so that the distance between the front seat and the floor tunnel can be made smaller to thereby achieve a compact structure. Further, since the bag-shaped portion located above the curved section is arranged close to the lower end of the console box disposed above the floor tunnel, an upper part of a carpet, which is attached extending from an outer part of the air conditioning duct into a lower part of the console box, can be restrained from collapsing on the inside of the console box. As a result, the likelihood of a finger entering between the carpet and the lower part of the console box can be reduced. Further, since the bag-shaped portion is configured to be in communication with the flow path portion, the bag-shaped portion and the flow path portion can be formed integrally by resin molding.

In a vehicle air conditioning duct according to the present disclosure, the main body section has a flat shape having a width larger than a height, and is arranged such that a widthwise face faces the side face of the floor tunnel. The bag-shaped portion of the curved section may have an upper face located at the same height as an upper face of the main body section.

Since the main body section has a flat shape having a width larger than a height, and is arranged such that a widthwise face faces the side face of the floor tunnel, the height by which the main body section projects from the side face of the floor tunnel toward the front seat can be reduced, so that the distance between the front seat and the floor tunnel can be made smaller to thereby achieve a compact structure. Further, since the upper face of the bag-shaped portion is located at the same height as the upper face of the main body section, the upper part of the bag-shaped portion and the upper part of the main body section are both arranged close to the lower end of the console box disposed above the floor tunnel, so that collapsing of the upper part of the carpet can be more effectively restrained.

In a vehicle air conditioning duct according to the present disclosure, the air discharge section has a flat shape having a width larger than a height, and includes: a cross portion connected to the lower part of the rear end portion of the main body section and extending outward in the vehicle width direction; and a bend portion connected to an outward part, in the vehicle width direction, of the cross portion and bending toward the vehicle rear. The blowing outlet is provided at a rear end of the bend portion. The bend portion may include a partition that divides, in the width direction, a flow path for allowing flow of conditioned air.

With this arrangement, air from the blowing outlet can be blown out uniformly along the vehicle width direction.

According to the present disclosure, space occupied by an air conditioning duct can be reduced and device installation space can thereby be increased.

### BRIEF DESCRIPTION OF DRAWINGS

Embodiment(s) of the present disclosure will be described based on the following figures, wherein:

FIG. 1 is a plan view showing a vehicle cabin of a vehicle having mounted thereon an air conditioning duct according to an embodiment;

FIG. 2 is a cross-sectional view taken along line A-A shown in FIG. 1, and depicts a side face of the air conditioning duct according to the embodiment;

FIG. 3 is a cross-sectional view taken along line B-B shown in FIG. 1;

FIG. 4 is a cross-sectional view taken along line C-C shown in FIG. 1;

FIG. 5 is a perspective view showing an air discharge section of the air conditioning duct according to the embodiment; and

FIG. 6 is a cross-sectional view taken along line D-D shown in FIG. 5.

### DESCRIPTION OF EMBODIMENTS

A vehicle air conditioning duct 100 according to an embodiment is described below by reference to the drawings. The arrows FR, UP, and RH shown in the drawings respectively denote the front direction (i.e., the forward travel direction), upward direction, and right direction of the vehicle. Further, the opposite directions of the arrows FR, UP, and RH denote the rear direction, downward direction, and left direction of the vehicle. Hereinafter, when a description is given referring simply to longitudinal, lateral, and vertical directions, unless otherwise specified, these directions respectively denote the vehicle longitudinal direction, vehicle lateral direction (i.e., vehicle width direction), and vehicle vertical direction.

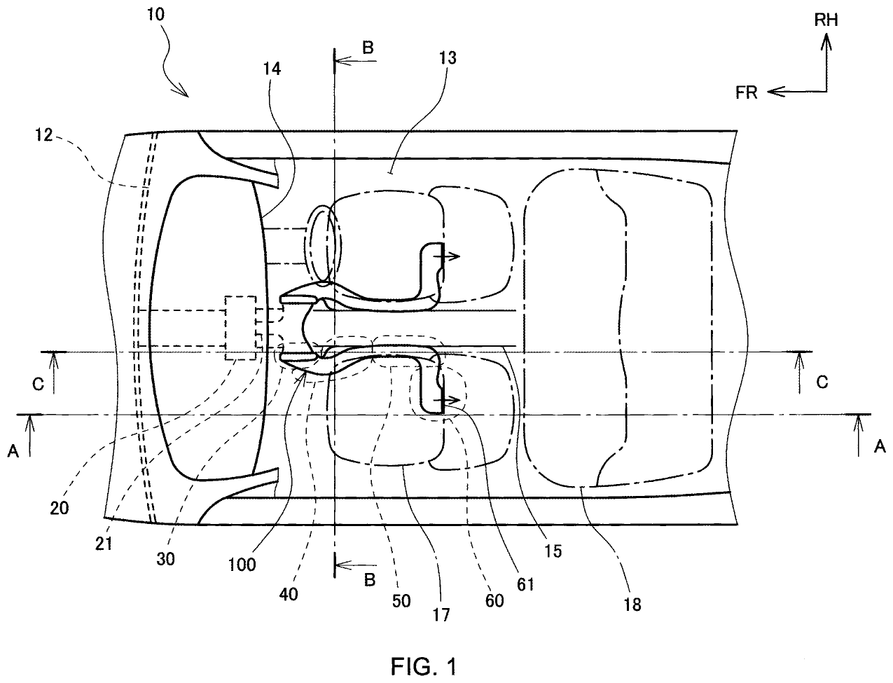

As shown in FIG. 1, the vehicle air conditioning duct 100 is arranged inside a vehicle cabin 13, and serves to introduce air from an air conditioner 20 provided in a front part of a vehicle 10 to a rear seat 18. The air conditioning duct 100 is composed of four sections; namely, an air intake section 30, a curved section 40, a main body section 50, and an air discharge section 60.

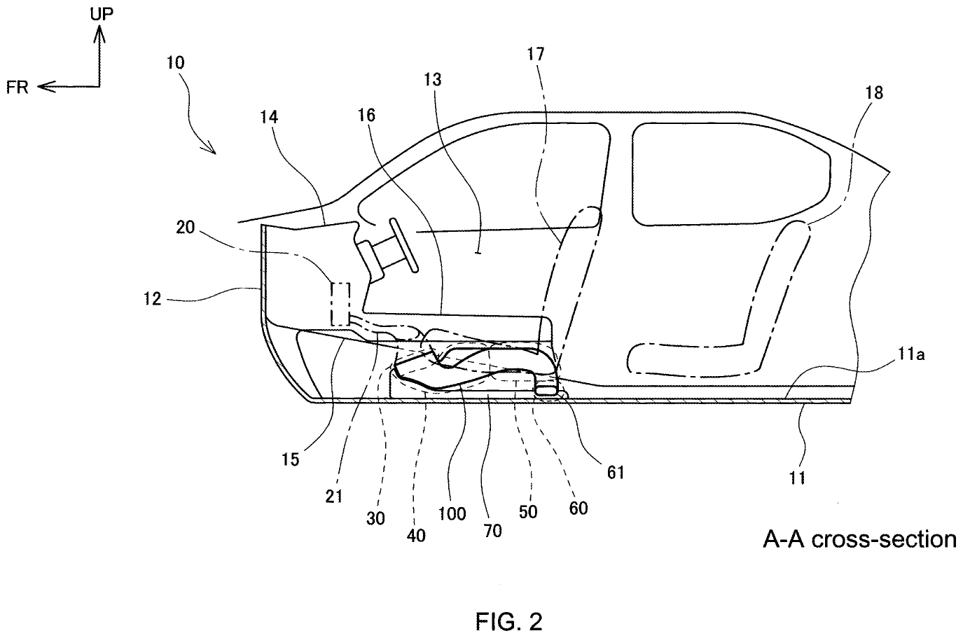

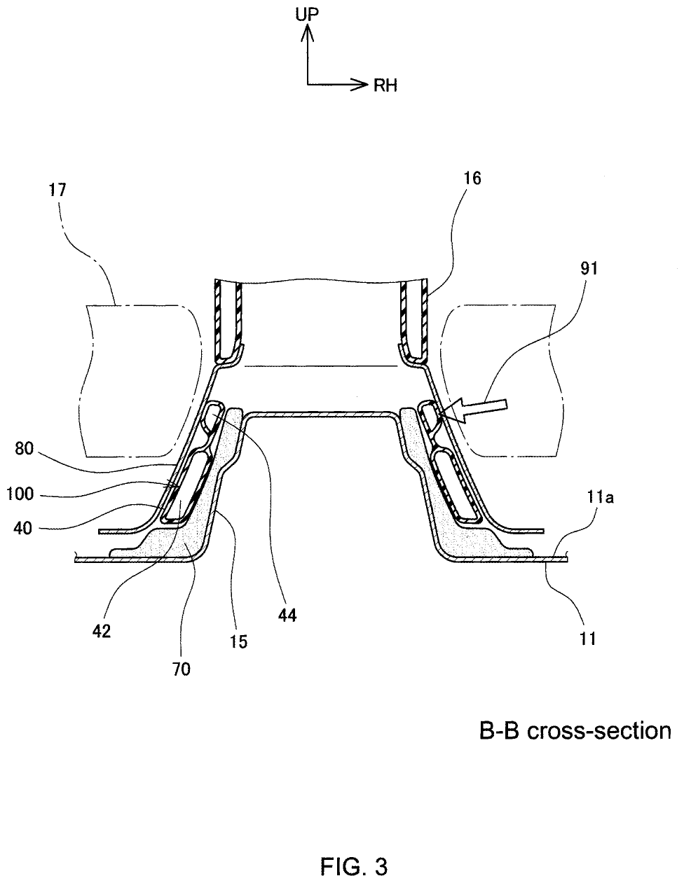

As shown in FIGS. 1 and 2, the front part of the vehicle cabin 13 is partitioned by a dash panel 12, while the lower part is partitioned by a floor panel 11 constituting a floor 11a. At a central part, in the vehicle width direction, of the floor panel 11, there is formed a floor tunnel 15 protruding upward from the floor 11a and extending in the vehicle longitudinal direction. As shown in FIG. 3, the floor tunnel 15 has a groove-shaped cross-section that protrudes upward, and extends from the dash panel 12 to an area under the rear seat 18, as shown in FIGS. 1 and 2. On the vehicle cabin 13 side of the dash panel 12, an instrument panel 14 is provided. In the space which is between the dash panel 12 and the instrument panel 14 and which is above the floor tunnel 15, the air conditioner 20 is installed. From the air conditioner 20, an upstream duct 21 extends along an upper part of the floor tunnel 15 toward the rear. The upstream duct 21 branches to left and right at a location near the front end of front seats 17, and the branches are connected respectively to the left and right air conditioning ducts 100. As shown in FIGS. 1 and 2, each air conditioning duct 100 first extends in the longitudinal direction along a side face of the floor tunnel 15, and subsequently, at a location under a rear end of the front seat, extends outward in the vehicle width direction, and is configured to blow air toward the rear seat 18.

As shown in FIG. 3, the air intake section 30, curved section 40, and main body section 50 of the air conditioning duct 100 are each a flat-shaped duct having a width larger than a height, and are each arranged such that a widthwise face faces a side face of the floor tunnel 15, with a sound absorbing material 70 placed therebetween. Further, on the floor 11a, a carpet 80 is overlaid. The carpet 80 is attached extending from the outward side, in the vehicle width direction, of the air intake section 30, curved section 40, and main body section 50, and into the lower part of a console box 16. Here, the widths of the air intake section 30, curved section 40, and main body section 50 each denote a flow path width observed when the air conditioning duct 100 is viewed from a lateral side of the vehicle, while the heights of the air intake section 30, curved section 40, and main body section 50 each denote an extent, in the vehicle width direction, of the flow path.

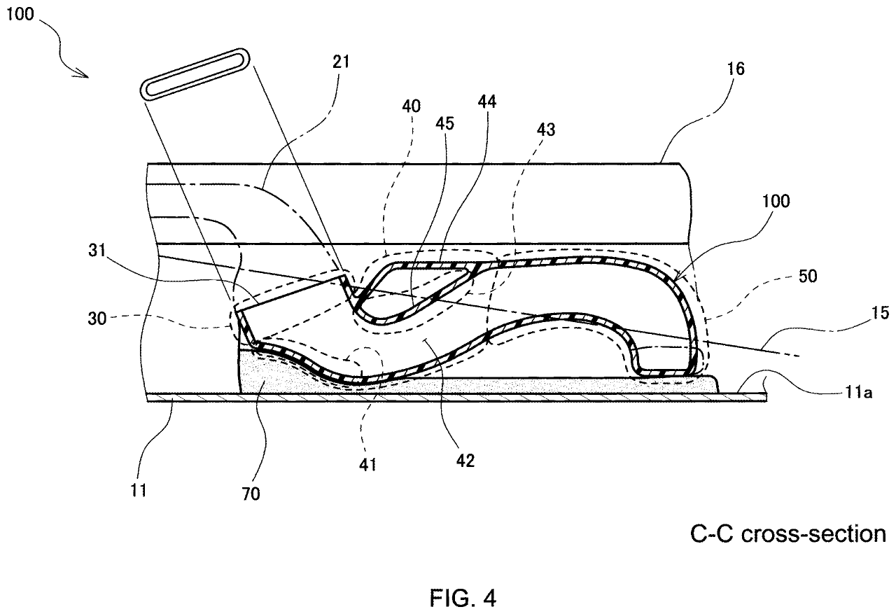

As shown in FIG. 4, the air intake section 30 is a part which, at its opening 31 that opens in the vehicle upward direction, is fitted to the upstream duct 21, and which extends in the vehicle downward direction. The curved section 40 is a part which is connected to the lower part of the air intake section 30 and which curves to protrude in the vehicle downward direction. After curving and protruding downward, the curved section 40 ascends in a diagonally rear direction of the vehicle, and continues on to the main body section 50. The main body section 50 is a part which is connected to the rear part of the curved section 40, and which extends in the vehicle rear direction along the floor tunnel 15. As shown in FIGS. 1 and 2, the air discharge section 60 is a part which is connected to the lower part of the rear end portion of the main body section 50, and which, at a location under the rear end of the front seat 17, extends outward in the vehicle width direction, and which includes a blowing outlet 61 for blowing air toward the rear seat 18.

As shown in FIG. 4, the width of the curved section 40 is smaller than the width of the air intake section 30. The curved section 40 is configured such that its front part located toward the vehicle front comprises a nozzle portion 41 in which the width of a flow path portion 42 gradually narrows as the nozzle portion extends downstream from a side end of the air intake section toward the vehicle rear. A part of the sound absorbing material 70 is arranged between a lower face of the nozzle portion 41 and the floor 11a, and the front part of the curved section 40 is supported by the sound absorbing material 70. Further, the sound absorbing material 70 is also arranged under the rear end portion of the main body section 50, and the rear end portion of the main body section 50 is similarly supported by the sound absorbing material 70.

As shown in FIG. 4, in the curved section 40, the flow path portion 42 for allowing flow of conditioned air comprises a downwardly protruding portion, and a portion which is located downstream of the downwardly protruding portion and which ascends in a diagonally rear direction of the vehicle. The part above the downwardly protruding portion and the portion ascending in the diagonally rear direction of the vehicle constitutes a dent portion 43 at a height that is lower than the upper face of the main body section 50. Above the dent portion 43, there is provided a bag-shaped portion 44 formed in a bag shape and in communication with the flow path portion 42 via a communicating hole 45. The height at which the upper face of the bag-shaped portion 44 is located is level with the upper face of the main body section 50. Further, as shown in FIGS. 2 and 4, the upper part of the bag-shaped portion 44 and the upper part of the main body section 50 are arranged close to the lower end of the console box 16 disposed above the floor tunnel 15.

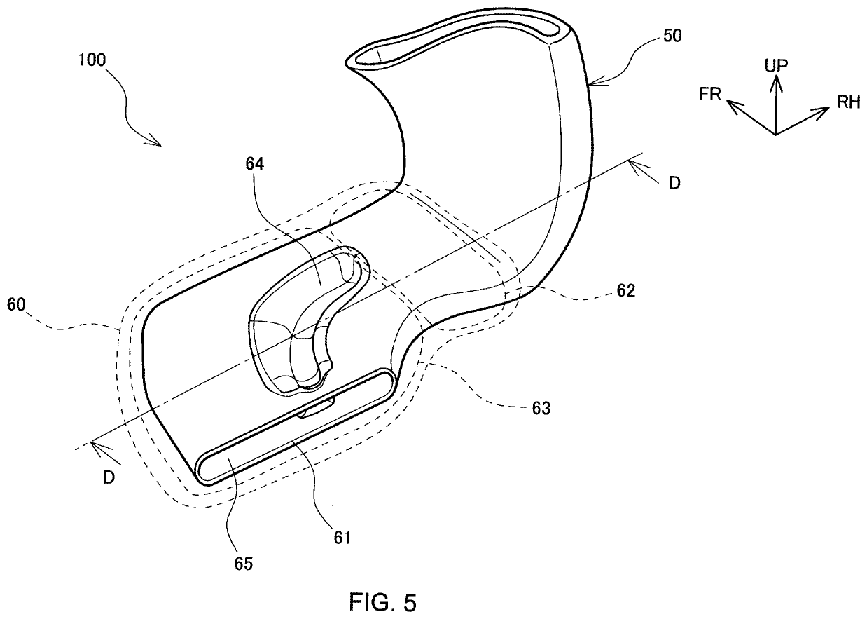

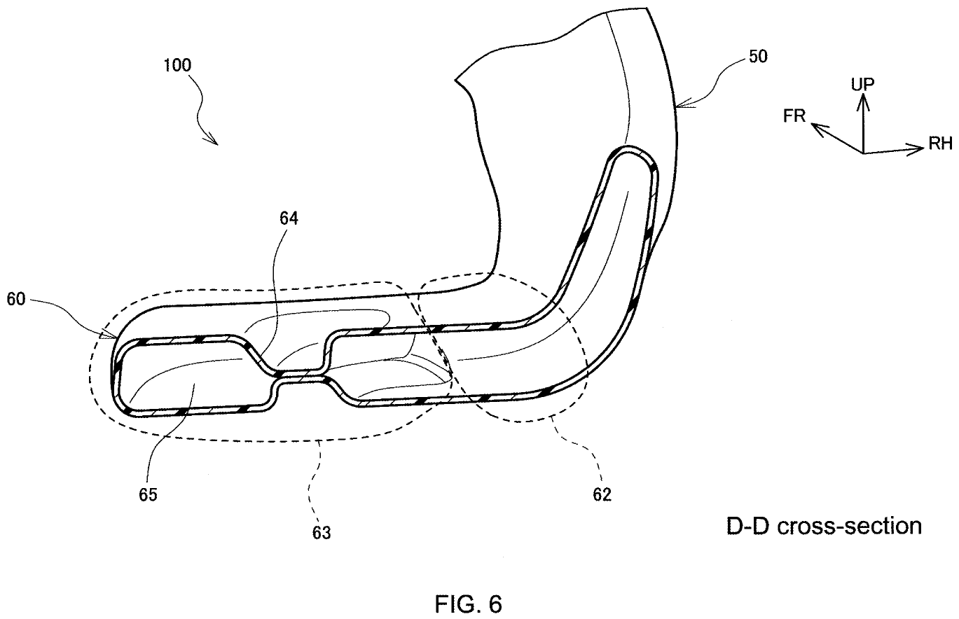

As shown in FIG. 5, the air discharge section 60 is a flat-shaped duct having a width larger than a height. Here, the width of the air discharge section 60 denotes a flow path width observed when the air conditioning duct 100 is viewed from the upper side of the vehicle, while the height of the air discharge section 60 denotes an extent, in the vehicle vertical direction, of the flow path. The air discharge section 60 includes: a cross portion 62 connected to the lower part of the rear end portion of the main body section 50 and extending outward in the vehicle width direction; a bend portion 63 connected to an outward part, in the vehicle width direction, of the cross portion 62 and bending toward the vehicle rear; and the blowing outlet 61 provided at the rear end of the bend portion 63. The bend portion 63 includes a partition 64 that divides, in the width direction, a flow path portion 65 for allowing flow of conditioned air. As shown in FIG. 6, the partition 64 is constituted with projections that project respectively from the upper and lower widthwise faces into the flow path portion 65, and, due to the upper and lower projections being in contact with each other, the flow path portion 65 is divided in the width direction.

Since the air conditioning duct 100 configured as described above does not extend under the central part of the front seat 17, the space occupied by the air conditioning duct 100 can be reduced and device installation space can be increased in the area under the front seat 17.

Further, the air intake section 30, curved section 40, and main body section 50 each have a flat shape having a width larger than a height, and are each arranged such that a widthwise face faces a side face of the floor tunnel 15. According to this arrangement, the height by which the air intake section 30, curved section 40, and main body section 50 project from the side face of the floor tunnel 15 toward the front seat 17 can be reduced, so that the distance between the front seat 17 and the floor tunnel 15 can be made smaller to thereby achieve a compact structure.

Further, by arranging the sound absorbing material 70 between the lower face of the nozzle portion 41 of the curved section 40 and the floor 11a, the front part of the air conditioning duct 100 can be supported by the sound absorbing material 70. Accordingly, fluttering of the air conditioning duct 100 during travelling can be suppressed. Furthermore, since the nozzle portion 41 can streamline the air flow from the air intake section 30 to the curved section 40, it is possible to reduce pressure loss.

Further, above the dent portion 43 defined at the part at which the flow path portion 42 of the curved section 40 is located lower than the upper face of the main body section 50, the bag-shaped portion 44 is provided at the same height as the upper face of the main body section 50, and the respective upper faces of the bag-shaped portion 44 and the main body section 50 are arranged close to the lower end of the console box 16. With this arrangement, when the carpet 80 on the outer side of the bag-shaped portion 44 is pressed with a finger as shown by an outlined arrow 91 in FIG. 3, the upper part of the carpet 80 abuts against the bag-shaped portion 44 and does not become jammed into the lower part of the console box 16. Accordingly, it is possible to reduce the likelihood that, when the carpet 80 is pressed, the upper part of the carpet 80 collapses and becomes jammed into the lower part of the console box 16 to create a gap between the carpet 80 and the console box 16, and, via this gap, the finger enters into the lower part of the console box 16, which may likely occur if the bag-shaped portion 44 is not provided.

Furthermore, since the bag-shaped portion 44 is in communication with the flow path portion 42 via the communicating hole 45, the bag-shaped portion 44 can be formed integrally with the curved section 40, the main body section 50, and the like by resin molding. As such, the bag-shaped portion 44 can be formed by a simple method.

Further, since the bend portion 63 of the air discharge section 60 includes the partition 64 that divides, in the width direction, the flow path portion 65 for allowing flow of conditioned air, the amount of air blown out from the blowing outlet 61 toward the rear seat 18 can be made uniform along the vehicle width direction.

It was explained that the air conditioning ducts 100 of the above-described embodiment are fitted respectively to the branches of the upstream duct 21, the upstream duct 21 extending from the air conditioner 20 along the upper part of the floor tunnel 15 toward the rear and then branching to left and right at a location near the front end of the front seats 17. However, the present disclosure is not limited to such an embodiment. The air conditioning ducts 100 may alternatively be connected to a single-path duct extending from the air conditioner 20. Further, although the curved section 40 was described above as curving to protrude in the vehicle downward direction, this is not a limitation, and the curved section 40 may alternatively be configured to curve by 90 degrees from an upper position toward the rear. Further, the air conditioning ducts 100 of the above-described embodiment may have any shape so long as the shape is a flat shape having a width larger than a height, and may for example have an oval cross-section, a quadrilateral cross-section such as a rectangular or rhombus cross-section, or an elliptical cross-section.

1. A vehicle air conditioning duct which is arranged inside a vehicle cabin and which introduces air from an air conditioner disposed in a front part of a vehicle to a rear seat, the vehicle air conditioning duct comprising:
an air intake section;
a curved section, which is connected to a lower part of the air intake section, and which is arranged on a side face of a floor tunnel, the floor tunnel projecting upward from a floor of the vehicle cabin at a central part in a vehicle width direction and extending in a vehicle longitudinal direction;
a main body section connected to a rear part of the curved section and extending toward a vehicle rear along the floor tunnel; and
an air discharge section, which is connected to a lower part of a rear end portion of the main body section, and which, at a location under a rear end of a front seat, extends outward in the vehicle width direction, the air discharge section having a blowing outlet for blowing air toward the rear seat.

2. The vehicle air conditioning duct according to claim 1, wherein
the air intake section and the curved section each have a flat shape having a width larger than a height, and are each arranged such that a widthwise face faces the side face of the floor tunnel, with a sound absorbing material placed therebetween;
the width of the curved section is smaller than the width of the air intake section, and the curved section is configured such that its front part located toward a vehicle front comprises a nozzle portion which has a width that gradually narrows as the nozzle portion extends downstream from a side end of the air intake section toward the vehicle rear; and
a part of the sound absorbing material is arranged between a lower face of the nozzle portion and the floor.

3. The vehicle air conditioning duct according to claim 1, wherein
the curved section has a flat shape having a width larger than a height, is arranged such that a widthwise face faces the side face of the floor tunnel, and includes: a flow path portion for allowing flow of conditioned air; and a bag-shaped portion formed in a bag shape and in communication with the flow path portion; and
the bag-shaped portion is arranged at a location above the flow path portion and close to a lower end of a console box disposed above the floor tunnel.

4. The vehicle air conditioning duct according to claim 2, wherein
the curved section has a flat shape having a width larger than a height, is arranged such that a widthwise face faces the side face of the floor tunnel, and includes: a flow path portion for allowing flow of conditioned air; and a bag-shaped portion formed in a bag shape and in communication with the flow path portion; and
the bag-shaped portion is arranged at a location above the flow path portion and close to a lower end of a console box disposed above the floor tunnel.

5. The vehicle air conditioning duct according to claim 3, wherein
the main body section has a flat shape having a width larger than a height, and is arranged such that a widthwise face faces the side face of the floor tunnel; and
the bag-shaped portion of the curved section has an upper face that is located at the same height as an upper face of the main body section.

6. The vehicle air conditioning duct according to claim 4, wherein
the main body section has a flat shape having a width larger than a height, and is arranged such that a widthwise face faces the side face of the floor tunnel; and
the bag-shaped portion of the curved section has an upper face that is located at the same height as an upper face of the main body section.

7. The vehicle air conditioning duct according to claim 1, wherein
the air discharge section has a flat shape having a width larger than a height, and includes: a cross portion connected to the lower part of the rear end portion of the main body section and extending outward in the vehicle width direction; and a bend portion connected to an outward part, in the vehicle width direction, of the cross portion and bending toward the vehicle rear;
the blowing outlet is provided at a rear end of the bend portion; and
the bend portion includes a partition that divides, in the width direction, a flow path for allowing flow of conditioned air.

8. The vehicle air conditioning duct according to claim 2, wherein
the air discharge section has a flat shape having a width larger than a height, and includes: a cross portion connected to the lower part of the rear end portion of the main body section and extending outward in the vehicle width direction; and a bend portion connected to an outward part, in the vehicle width direction, of the cross portion and bending toward the vehicle rear;
the blowing outlet is provided at a rear end of the bend portion; and
the bend portion includes a partition that divides, in the width direction, a flow path for allowing flow of conditioned air.

9. The vehicle air conditioning duct according to claim 3, wherein
the air discharge section has a flat shape having a width larger than a height, and includes: a cross portion connected to the lower part of the rear end portion of the main body section and extending outward in the vehicle width direction; and a bend portion connected to an outward part, in the vehicle width direction, of the cross portion and bending toward the vehicle rear;
the blowing outlet is provided at a rear end of the bend portion; and
the bend portion includes a partition that divides, in the width direction, a flow path for allowing flow of conditioned air.

10. The vehicle air conditioning duct according to claim 4, wherein
the air discharge section has a flat shape having a width larger than a height, and includes: a cross portion connected to the lower part of the rear end portion of the main body section and extending outward in the vehicle width direction; and a bend portion connected to an outward part, in the vehicle width direction, of the cross portion and bending toward the vehicle rear;
the blowing outlet is provided at a rear end of the bend portion; and
the bend portion includes a partition that divides, in the width direction, a flow path for allowing flow of conditioned air.
